(19) United States
(12) Patent Application Publication
(10) Pub. No.: US 2008/0219321 A1
(43) Pub. Date: Sep. 11, 2008

(54) Bimetal Thermometer Having a Heat Conductive Fluid

(76) Inventors: Pierre Charlety, Hong Kong (CN); Gao Yong Li, Shenzhen (CN)

Correspondence Address: CAHN & SAMUELS LLP, 1100 17th STREET NW, SUITE 401, WASHINGTON, DC, 20036, US

(21) Appl. No.: 11/684,095

(22) Filed: Mar. 9, 2007

(51) Int. Cl. G01K 5/66

(52) U.S. Cl. 374/207

(57) ABSTRACT

A bimetal thermometer includes a tubular housing and a shaft extending through the tubular housing. The shaft is attached at a top end to a pointer and is attached at a bottom end to a bimetal helical strip. A heat conductive fluid is in contact with the tubular housing and with the bimetal helical strip.

### I. FIELD OF THE INVENTION

This invention relates to a bimetal thermometer comprising a heat conductive fluid.

### II. BACKGROUND OF THE INVENTION

Different metals expand or contract at different rates when heated and cooled. Bimetal thermometers are constructed of two different metals bonded together. When heated, the combination of metals bend. The metal with the higher rate of expansion moves faster than the other metal.

A bimetal strip can be wound in the shape of a coil or loop, similar to a mainspring of a clock. In this shape, the coil winds or unwinds as the temperature changes. If one end of the coil is held so that it cannot move, the other end is free to move. Thus, a pointer may be attached to the free end so a temperature reading can register on a dial beneath the pointer. The temperature scale is accordingly calibrated to the bimetal strip.

If a bimetal strip is wound in the shape of a helix, the strip can be inserted into a tube. The tube is attached to a dial housing which contains the temperature scale. A thin rod is inserted into the tube and is welded to the end of the helix. As the helix winds or unwinds because of temperature changes, the rod also turns. A pointer is attached to the opposite end of the rod, and the temperature is indicated on a dial beneath the pointer.

U.S. Pat. No. 7,080,942 B2 to Handach discloses a bimetal thermometer comprising a bimetal helix arranged inside a protective tube, one end thereof being attached to the protective tube and the other end thereof being connected to a pointer shaft to which a pointer arranged inside a casing is attached. The pointer shaft is rotatably journaled in a bearing assembly in which a cavity is formed through which the pointer shaft extends. The cavity is filled with semisolid lubricating grease for damping vibration movements of the pointer shaft. The design of the bearing assembly and the pointer shaft permits a damped bimetal thermometer without a liquid filling being required in the casing and the protective tube or at least in the protective tube for the purpose of damping. In contrast, damping in other bimetal thermometers may be achieved by silicone oil filling.

U.S. Pat. No. 2,572,059 discloses a temperature-responsive device embodying a bimetallic coil. The coil is formed by two coil portions each coiled for a number of times in a spiral around a central axis. By forming the coil out of a thin bimetal of substantial width, the coil is given ample power to properly operate the instrument or device, and at the same time the total dimensions of the coil are kept to a minimum. The casing may be filled with a liquid of good heat transmitting properties, such as oil or glycerin.

### III. SUMMARY OF THE INVENTION

In an aspect of the invention, a bimetal thermometer is provided having a tubular housing and a shaft extending through the tubular housing. The shaft is attached at a top end to a pointer and attached at a bottom end to a bimetal helical strip. A heat conductive fluid is in contact with the tubular housing and with the bimetal helical strip.

In another aspect of the invention, the heat conductive fluid comprises a silicone oil. The silicone oil may comprise at least one thermally conductive powder, for example, at least one metal oxide, metal nitride, or metal carbide powder.

In another aspect of the invention, a bimetal thermometer is provided having a response time of about 4 seconds to about 5 seconds.

In another aspect of the invention, a bimetal thermometer is provided having a tubular housing and a shaft within the tubular housing. The shaft is attached at a top end to a pointer and attached at a bottom end to a bimetal helical strip. A gap between the bimetal helical strip and the tubular housing is about 0.15 mm to about 0.2 mm. A silicone oil is spread on the surface of the bimetal helical strip and on an inner surface of the tubular housing. The bimetal thermometer has a response time of about 4 seconds to about 5 seconds.

Given the following enabling description of the drawings, the apparatus should become evident to a person of ordinary skill in the art.

### IV. BRIEF DESCRIPTION OF THE DRAWINGS

The aspects of the present invention will become more readily apparent by describing in detail illustrative, non-limiting embodiments thereof with reference to the accompanying drawings.

The use of cross-hatching within these drawings should not be interpreted as a limitation on the potential materials used for construction of the invention. Like reference numerals in the figures represent and refer to the same element or function.

FIG. 1 illustrates a side view of an exemplary embodiment of a bimetal thermometer according to one embodiment of the present invention.

FIG. 2 illustrates a dial of an exemplary embodiment according to one embodiment of the present invention.

### V. DETAILED DESCRIPTION OF THE DRAWINGS

Exemplary, non-limiting, embodiments of the present invention are discussed in detail below. While specific configurations and dimensions are discussed to provide a clear understanding, it should be understood that the disclosed dimensions and configurations are provided for illustration purposes only. A person of ordinary skill in the art will recognize that other dimensions and configurations may be used without departing from the spirit and scope of the invention.

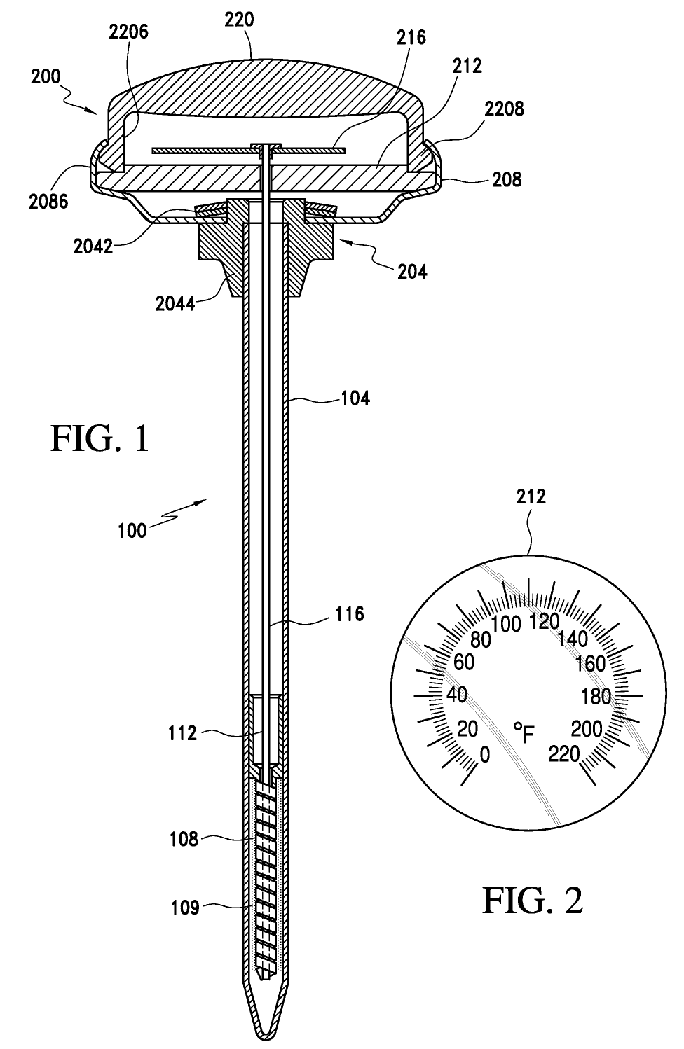

FIG. 1 illustrates an exemplary bimetal thermometer having a probe section (or probe unit) 100 and a display section 200.

The illustrated probe section 100 includes a tube (or stem) 104 having a bimetal helical strip 108 attached to a bushing 112. The bushing may be attached to the tube by any appropriate manner including, but not limited to, staking, rivets, welding, or adhesive. A shaft (or wire) 116 is attached to the bottom of the strip 108 and extends through tube 104. The bushing 112 allows the shaft 116 to freely rotate relative to the tube 104 as the strip 108 expands or contracts in response to the temperature. One of ordinary skill in the art will appreciate that different bimetal probes (including ones that omit the bushing 112) may be used as part of this invention as long as there is a tube 104 that can attach to the display section 200 and a shaft 116 extending through the tube 104.

The display section 200 includes a calibration member (or adjustor) 204 that attaches to the tube 104, a back case (or housing) 208, a dial (or temperature indicia member) 212, a pointer 216 that attaches to the shaft 116, and a lens 220. The pointer 216 can be any shape that is able, in conjunction with the dial, to inform a user of the temperature reading. The pointer 216 may be attached to the shaft 116 by any suitable manner including, but not limited to, adhesive, press-fitting, welding, or mounting.

The adjustor 204 is preferably integrally formed around the stem 104 to form an unitary piece. The adjustor 204 is coupled to the housing 208 as illustrated, for example, to allow for calibration adjustment of the thermometer when needed as the adjustor 204 is rotatable relative to the back case 208. One of ordinary skill in the art will appreciate that the adjustor 204 may engage the back case 208 such that no rotation or calibration is possible. The adjustor 204 includes a plurality of engagement members (or journals) 2042 extending from the turning member 2044. The journals engage back case 208.

The back case 208 together with the lens 220 forms an enclosed space for the dial 212 and the pointer 216 to reside in the thermometer. As illustrated, the back case 208 and the lens 220 clamp the dial 212 to secure the dial 212 in place.

The lens 220 may have a shape that includes a domed section on top of a cylindrical section having a circumferential protrusion (or rim). The exemplary shape of the back case 208 includes a section shaped to mesh with the lens 220 including a groove 2086 shaped to match the protrusion 2208 circumscribing the cylindrical section 2206 of the lens 220. Other frictional engagements between the back case 208 and the lens 220 are possible. One of ordinary skill in the art will appreciate the lens 220 may have a variety of cross-sections for viewing the dial 212.

In at least one embodiment, the lens 220 may be transparent polycarbonate. In embodiments, the dial 212 may be made from polycarbonate or acrylonitrile-butadiene-styrene (ABS). The back case 208, the tube 104, the adjustor 204, and the pointer 216 may be made from ABS with another exemplary material including polypropylene or polyvinyl chloride. The shaft 116 and the bushing 112 may be made from stainless steel. One of ordinary skill in the art will appreciate based on this description that the tube 104, back case 208, and adjustor 204 may be made of metal, for example, stainless steel instead of ABS.

As shown in FIG. 2, the dial 212 includes indicia of various temperatures such as 0 degrees to 220 degrees, but could be any temperature range desired in either Fahrenheit or Celsius. The dial 212 may include other indicia like color coded temperature range(s). The dial 212 may include a hole passing through its center for the shaft 116 to pass through. In embodiments, the dial 212 may also include a digital temperature indicator. The dial may be about 0.5 inch to about 2 inches in diameter, for example, about 1 inch in diameter.

In embodiments, the tube or stem 104 may be about 127 mm (5 inches) in length with an outer diameter of about 3.5 mm to 3.55 mm. The thickness of the tube or stem 104 may be about 0.18 mm to about 0.25 mm, for example, about 0.2 mm to about 0.25 mm. The pointed tip may have a length of about 5 mm. In embodiments, the bimetal helical strip 108 may have a length of about 26 mm or less with an outer diameter of about 2.5 mm to about 2.6 mm. In embodiments, the coil may have less than 20 turns or windings, for example, 16 windings. The gap between the bimetal helical strip 108 and the tube or stem 104 may be about 0.15 mm to about 0.2 mm.

According to the present invention, the bimetal helical strip 108 is in contact with a heat conductive fluid 109 which fills the tube or stem 104 below bushing 112, as shown in FIG. 1. Thus, the heat conductive fluid is in contact with the tubular housing and the bimetal helical strip. In embodiments, the heat conductive fluid may be spread on the surface of the bimetal helical strip and on the inner surface of the tubular housing. The oil thickness may be about 0.15 mm.

The heat conductive fluid 109 may comprise a silicone oil. In embodiments, the silicone oil may comprise at least one thermally conductive powder including, but not limited to, a metal oxide, metal nitride, or metal carbide powder, for example, silica (silicon dioxide) or alumina (aluminum oxide). The heat conductive fluid may have a thermal conductivity of greater than about 0.7 W/m K as measured at room temperature. In embodiments, the heat conductive fluid may comprise G-747, commercially available from Shin-Etsu Chemical Co., Ltd. and having a thermal conductivity of about 0.9 W/m K to about 1.09 W/m K.

The bimetal thermometer of the present invention has a response time of about 4 seconds to about 5 seconds when placed into boiling water from room temperature. In contrast, other known bimetal thermometers without a heat conductive fluid have a response time of about 8 seconds to about 29 seconds under the same conditions. As used herein, “response time” means the time required for a room temperature thermometer to read 100° C. when placed in boiling water.

The present invention is further illustrated in the following non-limiting example:

### EXAMPLE

The bimetal thermometer of the present invention was tested against a commercially available Cooper Bimetal Thermometer, a Taylor Bimetal Thermometer, and a Farberware Bimetal Thermometer. Each thermometer was placed into boiling water from room temperature, and the response time was measured. As shown in the Table below, the bimetal thermometer according to the present invention had a shorter response time than any of the Cooper, Taylor and Farberware bimetal thermometers. The length of the bimetal thermometer of the present invention which is immersed in the boiling water to ensure that the coil is immersed (the immersion depth) is about 30 mm to about 32 mm. In contrast, the immersion depth of the Cooper bimetal thermometer is about 42 mm (helical coil length of about 32 mm) and the immersion depth of the Taylor bimetal thermometer is about 42 mm (helical coil length of about 32 mm).

| Bimetal Thermometer | Trial | Response Time |
|---|---|---|
| Bimetal Thermometer With | 1 | 4 seconds |
| Heat Conductive Oil, G-747 | 2 | 5 seconds |
| | 3 | 5 seconds |
| Cooper Bimetal Thermometer, | 1 | 25 seconds |
| Model No. 1246-02 | 2 | 27 seconds |
| | 3 | 29 seconds |
| Taylor Bimetal Thermometer, | 1 | 7 seconds |
| Model No. 5989 | 2 | 10 seconds |
| | 3 | 8 seconds |
| Farberware Bimetal | 1 | 14 seconds |
| Thermometer | | |
| Model No. 78746 | | |

As used above “substantially,” “generally,” “about”, and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic. As used in this disclosure, “in communication” includes the situations where two pieces abut each other, are connected to each other, engage each other, and integrally formed together as one piece.

Although the present invention has been described in terms of particular embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the embodiments described above can be configured without departing from the scope and spirit of the invention. Therefore, it is to be understood that, within the scope of the appended claims, the invention may be practiced other than as specifically described herein.

What is claimed is:

1. A bimetal thermometer, comprising:
a tubular housing;
a shaft extending through the tubular housing, said shaft attached at a top end to a pointer and attached at a bottom end to a bimetal helical strip; and
a heat conductive fluid in contact with the tubular housing and with the bimetal helical strip.

2. A bimetal thermometer according to claim 1, wherein the heat conductive fluid comprises a silicone oil.

3. A bimetal thermometer according to claim 2, wherein the silicone oil comprises at least one thermally conductive powder.

4. A bimetal thermometer according to claim 3, wherein the at least one thermally conductive powder comprises at least one metal oxide, metal nitride, or metal carbide powder.

5. A bimetal thermometer according to claim 3, wherein the at least one thermally conductive powder comprises at least one metal oxide.

6. A bimetal thermometer according to claim 5, wherein the at least one metal oxide comprises silica.

7. A bimetal thermometer according to claim 5, wherein the at least one metal oxide comprises alumina.

8. A bimetal thermometer according to claim 1, wherein the heat conductive fluid has a thermal conductivity of greater than 0.7 W/m K.

9. A bimetal thermometer according to claim 1, wherein the tubular housing comprises stainless steel.

10. A bimetal thermometer according to claim 1, wherein the tubular housing has an outer diameter of about 3.5 mm.

11. A bimetal thermometer according to claim 1, wherein the thickness of the tubular housing is about 0.18 mm to about 0.25 mm.

12. A bimetal thermometer according to claim 1, wherein the bimetal helical strip has a length of about 26 mm and an outer diameter of about 2.5 mm to about 2.6 mm.

13. A bimetal thermometer according to claim 1, wherein a gap between the bimetal helical strip and the tubular housing is about 0.15 mm to about 0.2 mm.

14. A bimetal thermometer according to claim 1, wherein the bimetal thermometer has a response time of about 4 seconds to about 5 seconds.

15. A bimetal thermometer according to claim 1, wherein the bimetal helical strip has about 16 windings.

16. A bimetal thermometer, comprising:
a tubular housing;
a shaft within the tubular housing, said shaft attached at a top end to a pointer and attached at a bottom end to a bimetal helical strip, wherein a gap between the bimetal helical strip and the tubular housing is about 0.15 mm to about 0.2 mm; and
a silicone oil spread on the surface of the bimetal helical strip and spread on an inner surface of the tubular housing,
wherein the bimetal thermometer has a response time of about 4 seconds to about 5 seconds.

17. A bimetal thermometer according to claim 16, wherein the silicone oil comprises at least one thermally conductive powder.

18. A method of making a bimetal thermometer, comprising:
spreading a silicone oil on a surface of a bimetal helical strip;
spreading silicone oil on an inner surface of a housing; and
placing the bimetal helical strip in the housing.
